(19) United States
(12) Patent Application Publication
(10) Pub. No.: US 2025/0253389 A1
(43) Pub. Date: Aug. 7, 2025

(54) METHOD OF MANUFACTURING SOLID ELECTROLYTE USING WET MILLING

(71) Applicants: Hyundai Motor Company, Seoul (KR); Kia Corporation, Seoul (KR)

(72) Inventors: Yong Gu Kim, Seoul (KR); Sang Heon Lee, Seoul (KR); Sun Ho Choi, Seoul (KR); Sung Man Cho, Seoul (KR); Yong Jun Jang, Seoul (KR); Seong Hyeon Choi, Seoul (KR)

(21) Appl. No.: 18/825,397

(22) Filed: Sep. 5, 2024

(30) Foreign Application Priority Data
Feb. 5, 2024 (KR) 10-2024-0017119

(51) Int. Cl. H01M 10/0562

(52) U.S. Cl. CPC H01M 10/0562; H01M 2300/008

(57) ABSTRACT

Disclosed is a method of manufacturing a sulfide-based solid electrolyte using wet milling. The method includes preparing electrolyte precursor materials; adding the electrolyte precursor materials and milling balls to a container; adding a nonpolar solvent to the container; milling the electrolyte precursor materials with the milling balls to synthesize a solid electrolyte; and removing the nonpolar solvent by filtration from the solid electrolyte.

### CROSS-REFERENCE TO RELATED APPLICATION

This application claims, under 35 U.S.C. § 119 (a), the benefit of priority from Korean Patent Application No. 10-2024-0017119, filed on Feb. 5, 2024, the entire contents of which are incorporated herein by reference.

### BACKGROUND

### (a) Technical Field

The present disclosure relates to a method of manufacturing a sulfide-based solid electrolyte using wet milling.

### (b) Background

Methods of synthesizing solid electrolytes include wet methods and dry methods.

A wet method is suitable for mass production by synthesizing a solid electrolyte by adding precursors thereof to a polar solvent. However, the wet method requires the use of a large amount of solvent and additional processes and costs to remove the solvent after reaction. Additionally, the wet method has limitations in synthesizing a solid electrolyte doped with metal oxides with low reaction energy.

A dry method is a method of synthesizing a solid electrolyte by adding precursors thereof and balls and rotating the same. The dry method is mainly used, but the dry method causes powder to adhere to the inside of a milling jar after reaction, making recovery difficult. Moreover, the dry method generates heat during milling, making it difficult to use materials that are unstable at high temperatures.

### SUMMARY

In one aspect, an object of the present disclosure is to provide a new method of synthesizing a solid electrolyte.

In an aspect, another object of the present disclosure is to provide a method of easily synthesizing a solid electrolyte with high lithium ion conductivity.

Still another object of the present disclosure is to provide a method of synthesizing a solid electrolyte in a short time.

The objects of the present disclosure are not limited to the foregoing. The objects of the present disclosure will be able to be clearly understood through the following description and to be realized by the means described in the claims and combinations thereof.

In a further aspect, a method of manufacturing a solid electrolyte is provided, the method comprising: a) preparing one or more electrolyte precursor materials; b) adding the electrolyte precursor materials and milling balls to a container; c) adding a nonpolar solvent to the container; d) milling the electrolyte precursor materials with the milling balls to synthesize a solid electrolyte; and e) removing the nonpolar solvent by filtration from the solid electrolyte.

In aspects of the present methods, the solid electrolyte suitably may include a sulfide-based solid electrolyte.

In aspects of the present methods, the solid electrolyte may have an argyrodite-based crystal structure.

In aspects of the present methods, the solid electrolyte may include a halogen element.

In aspects of the present methods, the nonpolar solvent may have vapor pressure of 15 kPa or less at 20° C.

In aspects of the present methods, the nonpolar solvent may have relative polarity of 0.12 or less.

In aspects of the present methods, the nonpolar solvent may include at least one selected from the group consisting of toluene, xylene, heptane, cyclohexane, and combinations thereof.

In aspects of the present methods, the nonpolar solvent may be added to a container or reaction vessel in 50 vol % or less based on the total volume of the container or reaction vessel. The nonpolar solvent may be added to the container or reaction vessel in 10 vol % or more based on the total volume of the container or reaction vessel.

In aspects of the present methods, the nonpolar solvent may be added to the container (reaction vessel) in a volume corresponding to 1 to 2 times the sum of volumes of the precursors and the milling balls.

Milling the electrolyte precursor materials with milling balls may include milling the electrolyte precursor materials with the milling balls under conditions of 200 RPM to 800 RPM for 6 hours to 24 hours.

Removing the nonpolar solvent by filtration may include removing the nonpolar solvent by filtration under reduced pressure.

Removing the nonpolar solvent by filtration may include removing the nonpolar solvent by filtration using a filter paper including glass fiber.

Removing the nonpolar solvent by filtration may include removing the nonpolar solvent by filtration using a filter paper having a pore size of 2 μm or less.

The method may further include heat-treating the solid electrolyte.

Heat-treating the solid electrolyte may be performed at 300° C. to 550° C. for 10 minutes to 3 hours.

The electrolyte precursor materials may include a lithium source selected from the group consisting of Li₂S, Li₂S₂, Li₂S₄, Li₂S₈, elemental lithium, and a combination thereof.

The electrolyte precursor materials may include a phosphorus source selected from the group consisting of P₂S₃, P₂S₅, elemental phosphorus, and a combination thereof. The electrolyte precursor materials may include a halogen compound selected from the group consisting of LiCl, LiBr, LiI, and a combination thereof.

The method may further include drying the solid electrolyte using vacuum drying or room-temperature drying.

Other aspects are disclosed infra.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows an all-solid-state battery according to the present disclosure;

FIG. 2 shows a container in which electrolyte precursor materials, milling balls, and a nonpolar solvent are placed;

FIG. 3 shows results of measurement of particle size distribution of solid electrolytes according to Examples 1 and 2;

FIG. 4 shows results of X-ray diffraction analysis of the solid electrolyte according to Example 1;

FIG. 5 shows results of X-ray diffraction analysis of the solid electrolyte according to Example 2;

FIG. 6 shows results of X-ray diffraction analysis of a solid electrolyte according to Example 3; and

FIG. 7 shows results of X-ray diffraction analysis of a solid electrolyte according to Example 4.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

A term “all-solid-state battery” as used herein includes a rechargeable secondary battery that includes an electrolyte in a solid state which may include other electrolytic components for transferring ions between the electrodes of the battery.

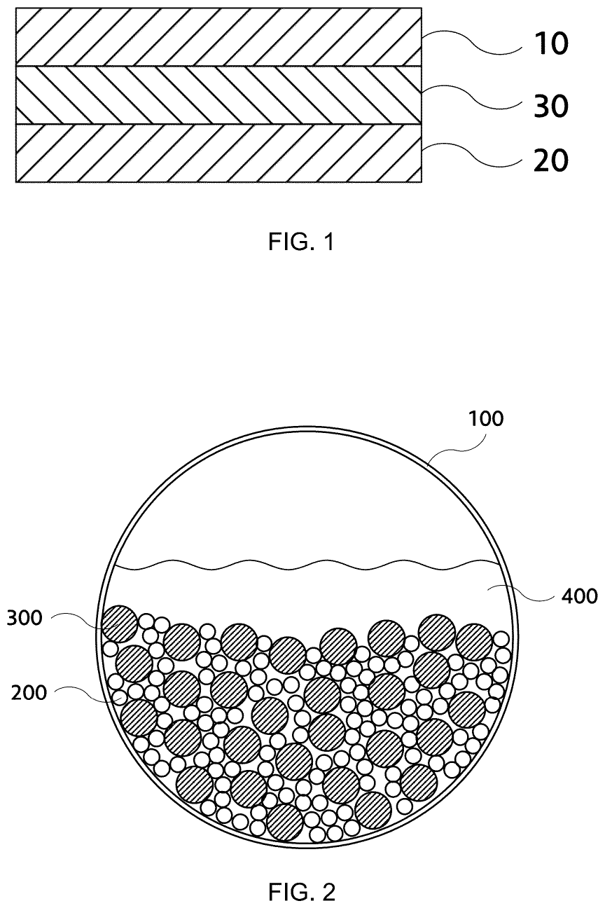

FIG. 1 shows an all-solid-state battery according to the present disclosure. The all-solid-state battery may include a cathode layer 10, an anode layer 20, and a solid electrolyte layer 30 disposed between the cathode layer 10 and the anode layer 20.

At least one selected from among the cathode layer 10, the anode layer 20, and the solid electrolyte layer 30 may include a solid electrolyte.

The solid electrolyte according to an embodiment of the present disclosure may include a sulfide-based solid electrolyte represented by Chemical Formula 1 below.

Li₃PS₄ [Chemical Formula 1]

The solid electrolyte may be crystalline, amorphous, or in a mixed state thereof. Preferably, the solid electrolyte is crystalline.

The solid electrolyte, according to another embodiment of the present disclosure, may have an argyrodite-type crystal structure and may include a sulfide-based solid electrolyte represented by Chemical Formula 2 below.

Li₇₋ₐPS₆₋ₐXₐ [Chemical Formula 2]

In Chemical Formula 2, X may include chlorine (Cl), bromine (Br), or iodine (I), and a may satisfy 0<a≤2.

The solid electrolyte, according to still another embodiment of the present disclosure, may have an argyrodite-type crystal structure and may include a sulfide-based solid electrolyte represented by Chemical Formula 3 below.

Li_{7-b-c}PS_{6-b-c}X1_{b}X2_{c} [Chemical Formula 3]

In Chemical Formula 3, X1 and X2 may be different from each other, each may include chlorine (Cl), bromine (Br), or iodine (I), and b and c may satisfy 0<b≤1 and 0<c≤1.

The solid electrolyte having the argyrodite-type crystal structure may mean having a crystalline phase showing characteristic peaks at 2θ=15.34°±1.00°, 17.74°±1.00°, 25.19°±1.00°, 29.62°±1.00°, 30.97°±1.00°, 44.37°±1.00°, and 47.22°±1.00° in X-ray diffraction measurement. The amount of the argyrodite-type crystal structure in the total crystal structure of the solid electrolyte may be 50 wt % or more, 70 wt % or more, or 90 wt % or more.

The solid electrolyte may further include a substitution element or a doping element that substitutes for lithium, phosphorus, or sulfur. The substitution element or the doping element may include boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), selenium (Se), silver (Ag), cadmium (Cd), indium (In)), tin (Sn), antimony (Sb), tellurium (Te), lead (Pb), bismuth (Bi), and others.

In one aspect, ae method of manufacturing the solid electrolyte includes preparing one or more electrolyte precursor materials, adding the electrolyte precursor materials and milling balls to a container or reaction vessel, adding a nonpolar solvent to the container, synthesizing a solid electrolyte by milling the electrolyte precursor materials with the milling balls, obtaining a solid electrolyte by removing the solvent by filtration, and heat-treating the solid electrolyte.

The types of electrolyte precursor materials are not particularly limited and may include, for example, a lithium source, a phosphorus source, and a halogen compound.

The lithium source may include Li₂S, Li₂S₂, Li₂S₄, Li₂S₈, elemental lithium, etc. The phosphorus source may include P₂S₃, P₂S₅, elemental phosphorus, etc. The halogen compound may include LiCl, LiBr, LiI, etc. The precursors may further include a compound of elemental sulfur, the substitution element, or the doping element.

The amount of each electrolyte precursor material may be appropriately adjusted to suit the desired composition of the solid electrolyte.

The electrolyte precursor materials and the milling balls may be added to a container, and the nonpolar solvent may be added to the container. The order of adding the electrolyte precursor materials and the milling balls to the container and adding the nonpolar solvent to the container is not particularly limited. The order in which the electrolyte precursor materials, the milling balls, and the nonpolar solvent are added is not particularly limited. The electrolyte precursor materials and the milling balls may be added to the container, followed by the addition of the solvent. Alternatively, the solvent may be added to the container first, followed by the addition of the electrolyte precursor materials and the milling balls.

FIG. 2 shows a container 100 in which electrolyte precursor materials 200, milling balls 300, and a nonpolar solvent 400 are placed.

The shape and size of the container 100 are not particularly limited.

The milling balls 300 may include zirconia balls or alumina balls. The diameter of the milling balls 300 is not particularly limited and may be, for example, 0.1 mm to 20 mm or 0.1 to 10 mm or 15 mm. In further aspects, the milling ball can be one of stainless steel ball, agate ball, zirconia ball, alumina ball or silicon carbide ball; the diameter of the ball is 0.1 mm or 1 mm to 15 mm or 200 mm.

The precursors 200 and the milling balls 300 may be added to the container 100 in a mass ratio of 1:1 to 1:10.

In addition to or in place of the milling balls, other methods and apparatus for agitation of the electrolyte precursor materials/solvent also may be employed, such as a mixing or shearing blade or other agitation including vigorous agitation with or without a further mechanical mixing element such as milling balls or a shearing or stirring blade.

A conventional method of synthesizing a solid electrolyte in a wet manner includes adding precursors and a polar solvent such as tetrahydrofuran or acetonitrile able to dissolve the precursors to a container, and then applying energy to the precursors with stirring. A conventional wet method has low yield because energy applied to the precursors is low, and is unsuitable for synthesizing a solid electrolyte including a substitution element or a doping element.

On the other hand, a conventional method of synthesizing a solid electrolyte in a dry manner includes adding electrolyte precursor materials and milling balls to a container and applying energy to the precursors by rotating the same. A solid electrolyte may be easily synthesized by applying energy through milling balls, but there are problems with the powder adhering to the inside of the container after the reaction or with damage to the electrolyte precursor materials caused by heat.

The present disclosure, similar to the conventional dry method, applies energy to the precursors 200 by rotating the mixture containing the electrolyte precursor materials 200 and the milling balls 300, but, similar to the conventional wet method, adds a nonpolar solvent to the mixture. The present disclosure is characterized by combining advantages of the dry method and the wet method.

According to the present disclosure, since electrolyte precursor materials sensitive to moisture, oxygen, etc. exist in a nonpolar solvent, side reaction of the electrolyte precursor materials does not occur compared to the conventional dry method, making it more stable.

Moreover, according to the present disclosure, when milling the electrolyte precursor materials, the electrolyte precursor materials do not adhere to the inner wall of the container due to the presence of the nonpolar solvent. As a result, energy is evenly transferred to the electrolyte precursor materials, leading to minimal variation in the properties of the result and excellent reproducibility.

Also, according to the present disclosure, aggregation of the solid electrolyte may be prevented because the nonpolar solvent exists between electrolyte precursor materials particles.

Unlike the conventional wet method, the present disclosure uses the nonpolar solvent 400. Therefore, electrolyte precursor materials may be prevented from reacting with a solvent.

The nonpolar solvent 400 may have vapor pressure of 15 kPa or less at 20° C. The lower limit of the vapor pressure is not particularly limited and may be 1 kPa or more. If the vapor pressure of the nonpolar solvent 400 exceeds 15 kPa, the nonpolar solvent 400 may evaporate excessively due to heat generated during milling, which may be dangerous.

The nonpolar solvent 400 may have relative polarity of 0.12 or less. The lower limit of the relative polarity is not particularly limited and may be 0.009 or more. The relative polarity may refer to the polarity of the corresponding sample when the polarity of water is set to 1.00. If the relative polarity of the nonpolar solvent 400 exceeds 0.12, the electrolyte precursor materials 200 may dissolve in the nonpolar solvent 400 and energy by the milling balls 300 may not be properly transferred.

The nonpolar solvent 400 may include at least one selected from the group consisting of toluene, xylene, heptane, cyclohexane, and combinations thereof.

The nonpolar solvent 400 may be added to the container 100 in 50 vol % or less based on the total volume of the container 100. For example, if the internal volume of the container 100 is 100 ml, 50 ml or less of the nonpolar solvent 400 may be added. The lower limit of the amount of the nonpolar solvent 400 that is added is not particularly limited and may be, for example, 10 vol % or more, 20 vol % or more, or 30 vol % or more. If the amount of the nonpolar solvent 400 that is added exceeds 50 vol %, collision energy that causes reaction may decrease, so the solid electrolyte may not be synthesized, and evaporation due to heat may increase, which may be dangerous. On the other hand, if the amount of the nonpolar solvent 400 added is less than 10 vol %, heat generated during milling may not be suppressed, which may be dangerous.

The nonpolar solvent 400 may be added to the container 100 in a volume corresponding to 1 to 2 times the sum of volumes of the electrolyte precursor materials 200 and the milling balls 300. If the amount of the nonpolar solvent 400 that is added exceeds 2 times, collision energy that causes the reaction may decrease, preventing the solid electrolyte from being synthesized, and evaporation due to heat may increase, which may be dangerous. On the other hand, if the amount of the nonpolar solvent 400 that is added is less than 1 time, the heat generated during milling may not be suppressed, which may be dangerous.

Synthesizing the solid electrolyte may include milling the precursors 200 with the milling balls 300 under conditions of 200 RPM to 800 RPM for 6 hours to 24 hours. When the rotation speed and time fall within the above ranges, the solid electrolyte may be sufficiently synthesized.

Since the nonpolar solvent is used in excess in the present disclosure, the nonpolar solvent must be removed to obtain the synthesized solid electrolyte. However, simply drying the nonpolar solvent may take too long. Therefore, the present disclosure is characterized by rapid removal of the nonpolar solvent by filtration.

Obtaining the solid electrolyte may include removing the nonpolar solvent by filtration under reduced pressure. Also, the nonpolar solvent may be removed by filtration with a filter paper including glass fiber and having a pore size of 2 μm or less.

Since general filter paper, including cellulose fiber, has a pore size of about 11 μm, the solid electrolyte may pass therethrough along with the nonpolar solvent. Also, the use of glass fiber, such as inorganic-based borosilicate, may prevent the solid electrolyte from reacting with the filter paper.

The solid electrolyte obtained by filtering the nonpolar solvent may be dried to completely remove the remaining nonpolar solvent. The drying process is not particularly limited and may include vacuum drying, room-temperature drying, etc., but taking into consideration economic efficiency and productivity, room-temperature drying is preferable. For example, the solid electrolyte may be dried at 15° C. to 25° C. for 10 minutes to 50 minutes.

Thereafter, the solid electrolyte thus obtained may be heat-treated at 300° C. to 550° C. for 10 minutes to 3 hours, increasing crystallinity of the solid electrolyte.

A better understanding of the present disclosure may be obtained through the following examples. These examples are merely set forth to illustrate the present disclosure, and are not to be construed as limiting the scope of the present disclosure.

### Example 1

Electrolyte precursor materials were prepared by weighing Li₂S, P₂S₅, LiBr, and LiCl according to the composition of Li_{5.4}PS_{4.4}Br_{0.8}Cl_{0.8}.

The electrolyte precursor materials and zirconia balls having a diameter of about 10 mm were placed in a container, and about 15 ml of toluene as a nonpolar solvent was added to the container.

A solid electrolyte was synthesized by milling the electrolyte precursor materials under conditions of about 200 RPM to 800 RPM for about 12 hours.

The nonpolar solvent was removed by filtration under reduced pressure, and a solid electrolyte was obtained. Filter paper including borosilicate glass and having a pore size of about 1.6 μm was used. The solid electrolyte thus obtained was dried at about 15° C. to 25° C. for about 30 minutes to completely remove the remaining nonpolar solvent.

The solid electrolyte was heat-treated at about 450° C. for about 2 hours.

### Example 2

A solid electrolyte was prepared in the same manner as in Example 1, with the exception that heptane was used as the nonpolar solvent.

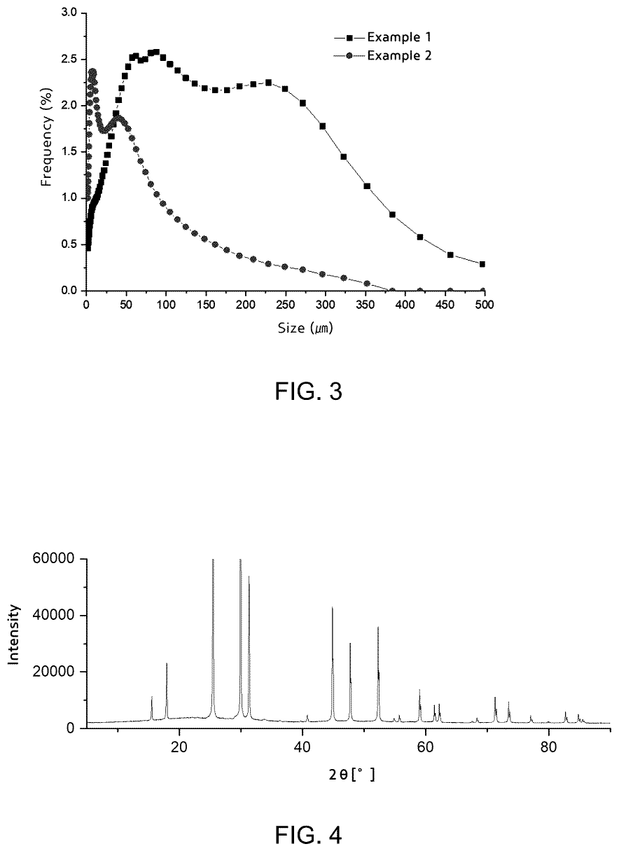

FIG. 3 shows results of measurement of particle size distribution of the solid electrolytes according to Examples 1 and 2. D₁₀, D₃₀, D₅₀, D₇₀, and D₉₀ of each solid electrolyte are shown in Table 1 below. In Example 1 using toluene, the proportion of particles with a large particle size increased, and a bimodal particle size distribution was clearly displayed. Example 2 using less polar heptane showed smaller particle sizes. As is apparent from the graph of FIG. 3, both Examples 1 and 2 had a low tendency for solid electrolyte particles to aggregate.

TABLE 1

| | | |
|---|---|---|
| Items | Example 1 (Toluene) | Example 2 (Heptane) |

| | | | | |
|---|---|---|---|---|
| D₁₀ | 3.81 | μm | 2.782 | μm |
| D₃₀ | 22.68 | μm | 4.83 | μm |
| D₅₀ | 55.46 | μm | 10.2 | μm |
| D₇₀ | 110.6 | μm | 25.98 | μm |
| D₉₀ | 241 | μm | 71.28 | μm |

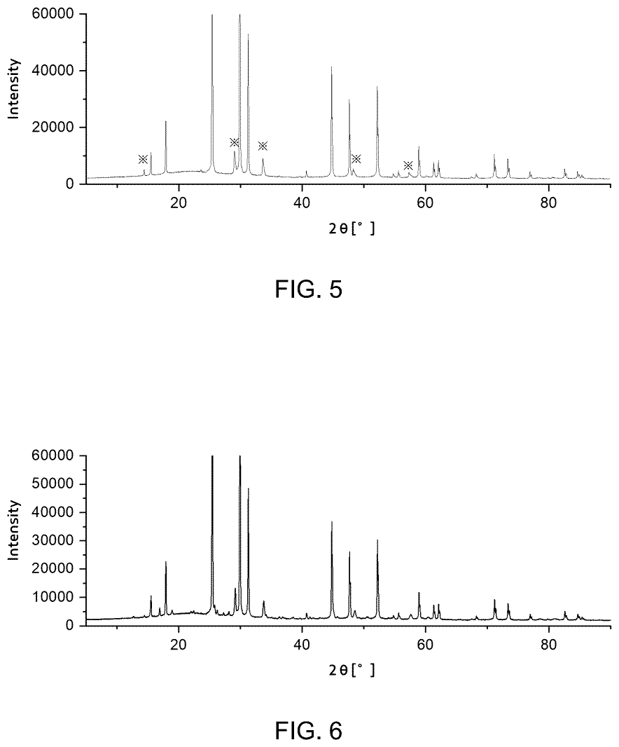

FIG. 4 shows results of X-ray diffraction analysis of the solid electrolyte according to Example 1. FIG. 5 shows results of X-ray diffraction analysis of the solid electrolyte according to Example 2. Example 1 showed peaks at 2θ=15.34°±1.00°, 17.74°±1.00°, 25.19°±1.00°, 29.62°±1.00°, 30.97°±1.00°, 44.37°±1.00°, and 47.22°±1.00° due to the argyrodite-type crystal structure. Example 2 additionally showed weak peaks at 2θ=14.41°±1.00°, 29.05°±1.00°, 33.76°±1.00°, and 48.45°±1.00°. These results were generally similar to results of a solid electrolyte synthesized using a conventional dry method.

### Example 3

A solid electrolyte was prepared in the same manner as in Example 1, with the exception that electrolyte precursor materials were prepared according to the composition of Li_{5.4}P_{0.9}Sn_{0.05}S_{4.25}Br_{0.8}Cl_{0.8}.

### Example 4

A solid electrolyte was prepared in the same manner as in Example 2, with the exception that electrolyte precursor materials were prepared according to the composition of Li_{5.4}P_{0.9}Sn_{0.05}S_{4.25}Br_{0.8}Cl_{0.8}.

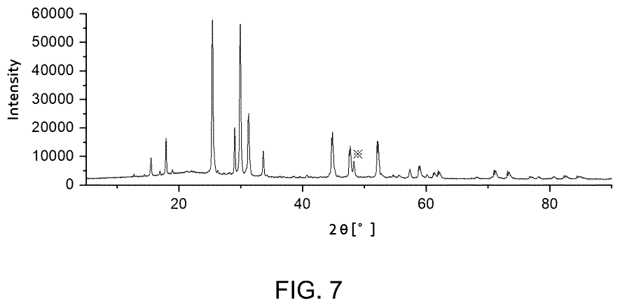

FIG. 6 shows results of X-ray diffraction analysis of the solid electrolyte according to Example 3. FIG. 7 shows results of X-ray diffraction analysis of the solid electrolyte according to Example 4. Comparing FIGS. 6 and 7, the peak at 48.59° observed in Example 3 using toluene down shifted to 48.32° in Example 4 using heptane. In addition, some peaks down shifted when heptane was used, which is deemed to be due to the effect of lattice expansion.

### Example 5

A solid electrolyte was prepared in the same manner as in Example 1, with the exception that electrolyte precursor materials were prepared according to the composition of Li₆PS₅Br_{0.5}Cl_{0.5}.

### Example 6

A solid electrolyte was prepared in the same manner as in Example 2, with the exception that electrolyte precursor materials were prepared according to the composition of Li₆PS₅Br_{0.5}Cl_{0.5}.

### Comparative Example 1

Electrolyte precursor materials were prepared by weighing Li₂S, P₂S₅, LiBr, and LiCl according to the composition of Li_{5.4}PS_{4.4}Br_{0.8}Cl_{0.8}.

The electrolyte precursor materials and zirconia balls having a diameter of about 10 mm were placed in a container, and about 15 ml of toluene as a nonpolar solvent was added to the container.

A solid electrolyte was synthesized by milling the electrolyte precursor materials under conditions of about 200 RPM to 800 RPM for about 12 hours.

The nonpolar solvent was removed by vacuum drying at about 60° C. for about 24 hours, and a solid electrolyte was obtained.

The solid electrolyte was heat-treated at about 450° C. for about 5 hours.

### Comparative Example 2

A solid electrolyte was prepared in the same manner as in Comparative Example 1, with the exception that heptane was used as the nonpolar solvent.

### Comparative Example 3

A solid electrolyte was prepared in the same manner as in Comparative Example 1, with the exception that electrolyte precursor materials were prepared according to the composition of Li_{5.4}P_{0.9}Sn_{0.05}S_{4.25}Br_{0.8}Cl_{0.8}.

### Comparative Example 4

A solid electrolyte was prepared in the same manner as in Comparative Example 2, with the exception that electrolyte precursor materials were prepared according to the composition of Li_{5.4}P_{0.9}Sn_{0.05}S_{4.25}Br_{0.8}Cl_{0.8}.

### Comparative Example 5

A solid electrolyte was prepared in the same manner as in Comparative Example 1, with the exception that electrolyte precursor materials were prepared according to the composition of Li₆PS₅Br_{0.5}Cl_{0.5}.

### Comparative Example 6

A solid electrolyte was prepared in the same manner as in Comparative Example 2, with the exception that electrolyte precursor materials were prepared according to the composition of Li₆PS₅Br_{0.5}Cl_{0.5}.

The lithium ion conductivity of the solid electrolytes according to Examples 1 to 6 and Comparative Examples 1 to 6 was measured. Each solid electrolyte was compression molded to produce a molded body for measurement (diameter: 13 mm, thickness: 0.6 mm). After applying an alternating potential of 10 mV to the molded body, frequency sweep of 1×10⁶ to 100 Hz was performed, and the impedance value was measured to calculate lithium ion conductivity. The results thereof are shown in Table 2 below.

TABLE 2

| | | | | Lithium ion |
|---|---|---|---|---|
| | | Nonpolar | Method of removing | conductivity |
| Classification | Composition | solvent | nonpolar solvent | [mS/cm] |
| Example 1 | Li_{5.4}PS_{4.4}Br_{0.8}Cl_{0.8} | Toluene | Filtration + drying at | 8.23 |
| Example 2 | | Heptane | room temperature | 7.21 |
| | | | under atmospheric | |
| | | | pressure + heat | |
| | | | treatment for 2 hours | |
| Comparative | | Toluene | Vacuum drying + | 9.16 |
| Example 1 | | | heat treatment for 5 | |
| Comparative | | Heptane | hours | 7.24 |
| Example 2 | | | | |
| Example 3 | Li_{5.4}P_{0.9}Sn_{0.05}S_{4.25}Br_{0.8}Cl_{0.8} | Toluene | Filtration + drying at | 4.78 |
| Example 4 | | Heptane | room temperature | 4.85 |
| | | | under atmospheric | |
| | | | pressure + heat | |
| | | | treatment for 2 hours | |
| Comparative | | Toluene | Vacuum drying + | 4.90 |
| Example 3 | | | heat treatment for 5 | |
| Comparative | | Heptane | hours | 4.53 |
| Example 4 | | | | |
| Example 5 | Li₆PS₅Br_{0.5}Cl_{0.5} | Toluene | Filtration + drying at | 2.03 |
| Example 6 | | Heptane | room temperature | 2.42 |
| | | | under atmospheric | |
| | | | pressure + heat | |
| | | | treatment for 2 hours | |
| Comparative | | Toluene | Vacuum drying + | 1.75 |
| Example 5 | | | heat treatment for 5 | |
| Comparative | | Heptane | hours | 2.47 |
| Example 6 | | | | |

Referring to Table 2, in Examples 1 to 6, the nonpolar solvent was removed by filtration and drying at room temperature under atmospheric pressure for about 30 minutes. Although the heat treatment was performed for 2 hours less than in Comparative Examples, the lithium ion conductivity thereof was equivalent to that of Comparative Examples 1 to 6. According to the present disclosure, it can be found that a solid electrolyte with excellent quality was manufactured in a very short time.

According to the present disclosure, a method of easily synthesizing a solid electrolyte with high lithium ion conductivity is provided.

According to the present disclosure, a method of synthesizing a solid electrolyte in a short time with excellent productivity is provided.

The effects of the present disclosure are not limited to the above-mentioned effects. It should be understood that the effects of the present disclosure include all effects that can be inferred from the description of the present disclosure.

As the examples of the present disclosure have been described in detail above, the scope of the present disclosure is not limited to the aforementioned examples and various modifications and improvements made by those skilled in the art using the basic concept of the present disclosure defined in the following claims are also within the scope of the present disclosure.

What is claimed is:

1. A method of manufacturing a solid electrolyte, the method comprising:
preparing one or more electrolyte precursor materials;
adding the electrolyte precursor materials and milling balls to a container;
adding a nonpolar solvent to the container;
milling the electrolyte precursor materials with the milling balls to synthesize a solid electrolyte; and
removing the nonpolar solvent by filtration from the solid electrolyte.

2. The method of claim 1, wherein the solid electrolyte comprises a sulfide-based solid electrolyte.

3. The method of claim 1, wherein the solid electrolyte has an argyrodite-based crystal structure.

4. The method of claim 1, wherein the solid electrolyte comprises a halogen element.

5. The method of claim 1, wherein the nonpolar solvent has a vapor pressure of 15 kPa or less at 20° C.

6. The method of claim 1, wherein the nonpolar solvent has a relative polarity of 0.12 or less.

7. The method of claim 1, wherein the nonpolar solvent comprises at least one selected from the group consisting of toluene, xylene, heptane, cyclohexane, and combinations thereof.

8. The method of claim 1, wherein the nonpolar solvent is added to the container in 50 vol % or less based on the total volume of the container.

9. The method of claim 8, wherein the nonpolar solvent is added to the container in 10 vol % or more based on the total volume of the container.

10. The method of claim 1, wherein the nonpolar solvent is added to the container in a volume corresponding to 1 to 2 times a sum of volumes of the electrolyte precursor materials and milling balls.

11. The method of claim 1, wherein milling the electrolyte precursor materials with the milling balls comprises milling the electrolyte precursor materials with the milling balls under conditions of 200 RPM to 800 RPM for 6 hours to 24 hours.

12. The method of claim 1, wherein removing the nonpolar solvent by filtration comprises removing the nonpolar solvent by filtration under reduced pressure.

13. The method of claim 1, wherein removing the nonpolar solvent by filtration comprises removing the nonpolar solvent by filtration using a filter paper comprising glass fiber.

14. The method of claim 1, wherein removing the nonpolar solvent by filtration comprises removing the nonpolar solvent by filtration using a filter paper having a pore size of 2 μm or less.

15. The method of claim 1, further comprising heat-treating the solid electrolyte.

16. The method of claim 15, wherein heat-treating the solid electrolyte is performed at 300° C. to 550° C. for 10 minutes to 3 hours.

17. The method of claim 1, wherein the electrolyte precursor materials comprise a lithium source selected from the group consisting of Li₂S, Li₂S₂, Li₂S₄, Li₂S₈, elemental lithium, and a combination thereof.

18. The method of claim 1, wherein the electrolyte precursor materials comprise a phosphorus source selected from the group consisting of P₂S₃, P₂S₅, elemental phosphorus, and a combination thereof and/or the electrolyte precursor materials comprise a halogen compound selected from the group consisting of LiCl, LiBr, LiI, and a combination thereof.

19. The method of claim 1, further comprising drying the solid electrolyte using vacuum drying or room-temperature drying.
